(19) United States
(12) Patent Application Publication
(10) Pub. No.: US 2020/0243081 A1
(43) Pub. Date: Jul. 30, 2020

(54) VOICE RECOGNITION DEVICE AND VOICE RECOGNITION METHOD

(71) Applicants: KABUSHIKI KAISHA TOSHIBA, Tokyo (JP); TOSHIBA ELECTRONIC DEVICES & STORAGE CORPORATION, Tokyo (JP)

(72) Inventors: Yusaku KIKUGAWA, Nishitama Tokyo (JP); Yasuyuki MASAI, Yokohama Kanagawa (JP); Keizo YAMASHITA, Yokohama Kanagawa (JP)

(73) Assignees: KABUSHIKI KAISHA TOSHIBA, Tokyo (JP); TOSHIBA ELECTRONIC DEVICES & STORAGE CORPORATION, Tokyo (JP)

(21) Appl. No.: 16/529,555

(22) Filed: Aug. 1, 2019

(30) Foreign Application Priority Data
Jan. 25, 2019 (JP) 2019-011602

(51) Int. Cl. G10L 15/22; G10L 15/08

(52) U.S. Cl. CPC G10L 15/22; G10L 2015/088; G10L 2015/223; G10L 15/08

(57) ABSTRACT

According to an embodiment, a voice recognition device includes a voice trigger detection unit that detects a keyword from a voice signal, and a similar keyword identification unit that calculates a degree of priority of the keyword depending on a time when the keyword is detected and a similarity between the voice signal and the keyword and outputs an identification code that corresponds to the keyword based on the degree of priority.

### CROSS-REFERENCE TO RELATED APPLICATIONS

This application is based upon and claims the benefit of priority from Japanese Patent Application No. 2019-011602, filed on Jan. 25, 2019; the entire contents of which are incorporated herein by reference.

### FIELD

The present embodiment generally relates to a voice recognition device and a voice recognition method.

### BACKGROUND

A technique of a voice recognition device that includes a voice trigger detection unit is disclosed conventionally. A voice trigger detection unit outputs, in a case where a voice signal that includes a preliminarily registered keyword is detected, an identification code that corresponds to such a keyword. In order to improve a functionality of a process that is executed by a voice trigger, multiple similar keywords may be registered. Hence, a voice recognition device and a voice recognition method are desired that are capable of accurately recognizing, in a case where multiple keywords are detected for an input voice signal, what keyword is an optimum keyword.

### BRIEF DESCRIPTION OF THE DRAWINGS

FIG. 1 is a diagram illustrating a configuration of a voice recognition device according to a first embodiment.

FIG. 2 is a diagram for explaining an operation of the first embodiment.

FIG. 3 is a diagram for explaining an operation of the first embodiment.

FIG. 4 is a flowchart illustrating an operation example of the first embodiment.

FIG. 5 is a diagram illustrating a configuration of a voice recognition device according to a second embodiment.

### DETAILED DESCRIPTION

According to one embodiment, a voice recognition device includes a voice trigger detection unit that detects a keyword from a voice signal, and a similar keyword identification unit that calculates a degree of priority of the keyword depending on a time when the keyword is detected and a similarity between the voice signal and the keyword and outputs an identification code that corresponds to the keyword based on the degree of priority.

Hereinafter, a voice recognition device and a voice recognition method according to embodiments will be explained in detail with reference to the accompanying drawings. Additionally, the present invention is not limited by such embodiments.

### First Embodiment

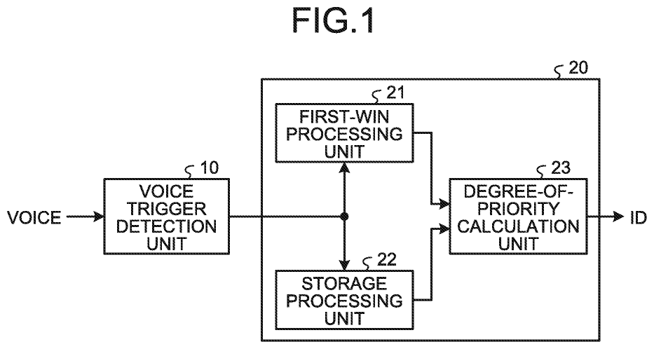

FIG. 1 is a diagram illustrating a configuration of a voice recognition device according to a first embodiment. The present embodiment has a voice trigger detection unit 10 where a voice is input thereto and a similar keyword identification unit 20. The voice trigger detection unit 10 has a function of machine learning such as so-called deep learning. The voice trigger detection unit 10 compares input voice data and a preliminarily registered phonemic pattern, and outputs, in a case where it is determined from a result of such comparison that voice data that coincide with a preliminarily registered keyword are input, an identification code ID that corresponds to such a keyword.

Furthermore, the voice trigger detection unit 10 sequentially calculates and outputs a score (that may be referred to as aScore) dependent on a similarity between voice data and a preliminarily registered phonemic pattern. The voice trigger detection unit 10 calculates and outputs a score that indicates a similarity by, for example, a feature extraction process that compares a variation of an amplitude of voice data or formant and a preliminarily registered phonemic pattern. For example, in a case of a high similarity, a value of a score is decreased.

The voice trigger detection unit 10 outputs a time when a keyword is detected and information of a score that are associated with an identification code ID to the similar keyword identification unit 20. The similar keyword identification unit 20 has a first-win processing unit 21, a storage processing unit 22, and a degree-of-priority calculation unit 23.

The first-win processing unit 21 outputs information to increase a degree of priority in ascending order of a time when a keyword is detected, as well as a corresponding identification code ID, to the degree-of-priority calculation unit 23.

The storage processing unit 22 compares a score and a predetermined threshold value and calculates a storage time. A storage time indicates, for example, a length of a time when a score is below a threshold value. The storage processing unit 22 executes a process to provide information of a degree of priority depending on a storage time. For example, information to increase a degree of priority in descending order of a storage time among multiple keywords that are detected within a predetermined period of time is provided. The storage processing unit 22 outputs information of a degree of priority, as well as a corresponding identification code ID, to the degree-of-priority calculation unit 23.

For example, it is possible to obtain a distribution of scores in a case where a specific keyword is pronounced and a distribution of scores in a case where another one is pronounced preliminarily and experimentally by machine learning such as deep learning and set a threshold value at a value that properly distinguishes between such two distributions. Additionally, a configuration to execute setting of a threshold value and comparison between the threshold value and a score in the voice trigger detection unit 10 may be provided.

The storage processing unit 22 sets a mask period when output of an identification code ID is stopped. That is because a storage process is executed in parallel to a first-win process and an identification code ID that corresponds to a more proper keyword is output.

Information of a mask period is supplied to the degree-of-priority calculation unit 23. The degree-of-priority calculation unit 23 stops output of an identification code ID during a mask period in response to information of the mask period from the storage processing unit 22.

The degree-of-priority calculation unit 23 executes calculation of a degree of priority on what keyword is output, in response to output signals of the first-win processing unit 21 and the storage processing unit 22. It is possible for the degree-of-priority calculation unit 23 to calculate a degree of priority on each keyword based on a predetermined calculation formula. For example, an operation process is executed to execute predetermined weighting for a determination factor based on an order relation of a time when each keyword that is output from the first-win processing unit 21 is detected and a determination factor based on a similarity that is based on a length of a storage time that is supplied from the storage processing unit 22. For example, the degree-of-priority calculation unit 23 determines a degree of priority of a keyword in descending order of a calculated value and outputs an identification code ID that corresponds to a keyword with a highest degree of priority in a mask period.

Even in a case where a detection time of a keyword is earliest, a storage time is decreased in a case where a similarity between a phonemic pattern and voice data is low, that is, a score is higher than a threshold value. Therefore, it is possible to recognize a proper keyword that corresponds to voice data by adding a determination factor based on a storage time that indicates a similarity in addition to a determination factor based on an order relation of a detection time.

According to the present embodiment, in a case where multiple keywords are detected by the voice trigger detection unit 10, a degree of priority of a keyword is calculated based on an order relation of a detection time and a length of a storage time and an identification code ID that corresponds to a keyword with a highest degree of priority is output. Thereby, in a case where multiple keywords are detected from voice data, it is possible to provide proper recognition among such detected multiple keywords.

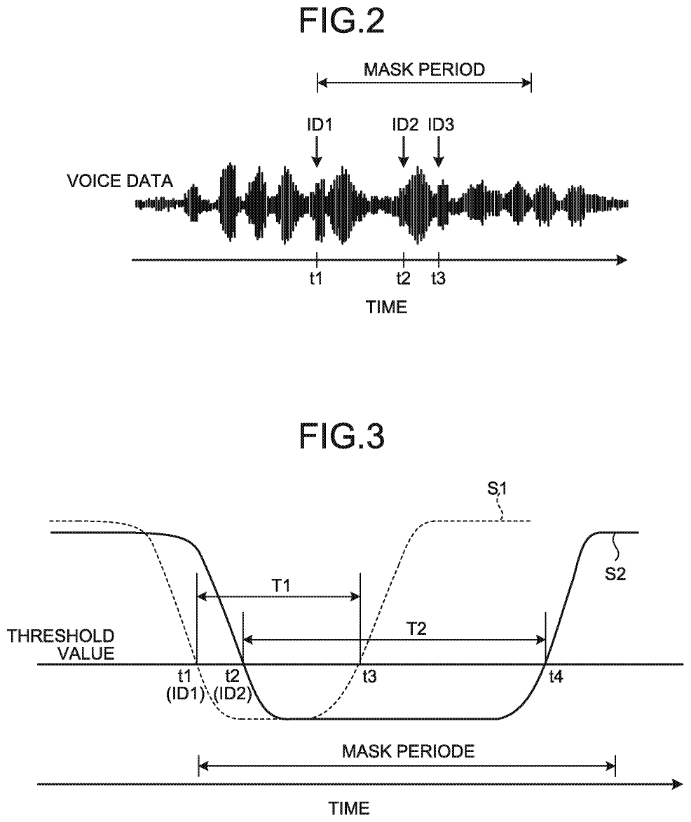

FIG. 2 is a diagram for explaining an operation of the first embodiment. A relation among voice data, timing when an identification code ID is output from the voice trigger detection unit 10, and a mask period is schematically illustrated where a horizontal axis is time.

As voice data are input, for example, a first keyword is detected at time t1, an identification code ID1 that corresponds to the detected first keyword is output. Similarly, a second keyword is detected at time t2 and an identification code ID2 that corresponds to such a second keyword is output. Moreover, a third keyword is detected at time t3 and an identification code ID3 that corresponds to such a third keyword is output.

A mask period is set in a predetermined period of time from t1 when an identification code ID1 that corresponds to a first keyword that is first detected is output. A mask period is set in, for example, the storage processing unit 22. For example, it is possible to set a mask period by taking into consideration a longest duration of preliminarily registered keyword and a period of time when a similar keyword is capable of being detected. Alternatively, a mask period may be set for each keyword. For example, it is possible to set a mask period by taking into consideration a period of time when a similar keyword is capable of being detected for each keyword and a duration of each keyword that is preliminarily registered.

FIG. 3 is a diagram for explaining an operation of the first embodiment. A relation among a score that is output from the voice trigger detection unit 10, a threshold value, timing when an identification code ID that corresponds to a detected keyword is output, and a mask period is schematically illustrated where a horizontal axis is time. A dotted line S1 indicates a score for a first keyword. A solid line S2 indicates a score for a second keyword. In the voice trigger detection unit 10, based on a result of comparison between voice date and phonemic pattern that is included in first and second keywords that are preliminarily registered, scores S1 and S2 that correspond to the respective keywords are output.

Comparison between the respective scores S1 and S2 and a threshold value is executed and identification codes ID that correspond to respective keywords are output at timing when the scores S1 and S2 are below the threshold value. For example, comparison between a phonemic pattern that is included in a registered first keyword and voice data is executed and an identification code ID1 is output at time t1. At time t3 when a score S1 is higher than a threshold value, a storage time T1 of a first keyword is measured in the storage processing unit 22.

Similarly, comparison between a phonemic pattern that is included in a registered second keyword and voice data is executed and an identification code ID2 is output at time t2. At time t4 when a score S2 is higher than a threshold value, a storage time T2 of a second keyword is measured in the storage processing unit 22. For example, a mask period is set at time t1 in the storage processing unit 22.

Lengths of storage times T1 and T2 are compared. Thereby, comparison of a similarity between voice data and each registered keyword is executed. As a storage time is long, a similarity is high, so that it is possible to provide proper recognition by comparing storage times.

For setting of a threshold value, it is possible to execute such setting for each keyword in the voice trigger detection unit 10. For example, it is possible to change a threshold value depending on a degree of whether or not it is readily recognized as a keyword. It is possible to execute adjustment to set a threshold value strictly in a case of a keyword that is readily detected and set a threshold value loosely for a keyword that is difficult to be detected. FIG. 3 conveniently illustrates a case where a common threshold value is used.

In a case of an example as illustrated in FIG. 3, a storage time T2 is longer than a storage time T1. Hence, even in a case where time t1 when an identification code ID1 is output is previous, it is possible to execute a process to determine that a degree of priority of a second keyword is high and output an identification code ID2.

For example, a score is calculated for each phoneme of voice data in the voice trigger detection unit 10. Therefore, a score of voice data only for a specific phoneme in a preliminarily registered keyword may be below a threshold value. That is, a score for a part of a preliminarily registered keyword may be below a threshold value. For example, in a case where the number of phonemes of a registered keyword is 10, a score of voice date for 8 phonemes therein may be below a threshold value. In such a case, it is possible to calculate a total of periods of time that correspond to 8 phonemes that are below a threshold value as a storage time of such a keyword.

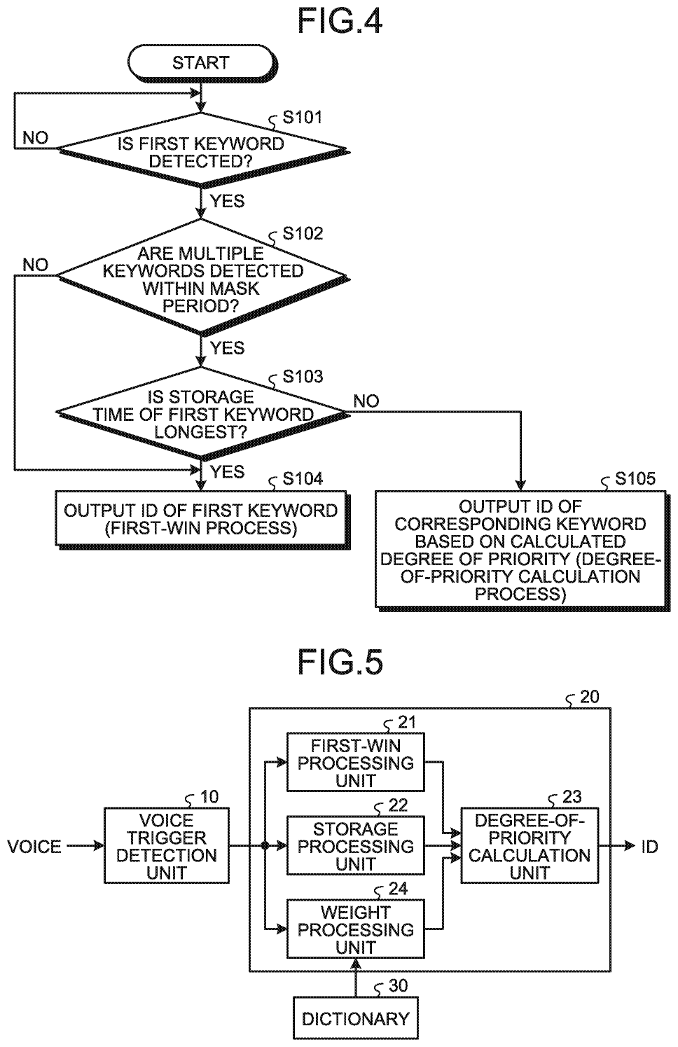

FIG. 4 is a flowchart illustrating an operation example in a case where multiple similar keywords are detected from voice data. In a case where a first keyword is detected from voice data (S101: Yes), determination of whether or not multiple keywords are detected within a predetermined mask period is executed (S102). In a case where a keyword is not detected from voice data (S101: No), detection of a keyword that is executed by the voice trigger detection unit 10 is continued.

In a case where multiple keywords are detected within a mask period (S102: Yes), whether or not a storage time of a first detected keyword is longest is determined (S103). That is, a process is executed that is based on a storage time that is measured by comparison of a score that indicates a similarity between a phonemic pattern of a registered keyword and voice data and a predetermined threshold value.

In a case where a storage time of a first detected keyword is longest (S103: yes), such an identification code ID is output (S104).

In a case where a storage time of a first detected keyword is not longest (S103: No), a degree of priority of each detected keyword is calculated and an identification code ID with a highest degree of priority is output (S105). For example, an identification code ID is output that corresponds to a keyword with a longest storage time when a score is below a threshold, among keywords detected within a predetermined mask period.

A degree of priority is calculated based on a detection time of a keyword and a length of a storage time that indicates a similarity, so that it is possible to reduce a risk of recognizing an erroneous keyword. Thereby, it is possible to provide a voice recognition device and a voice recognition method that are capable of recognizing a proper keyword from voice data.

### Second Embodiment

FIG. 5 is a diagram illustrating a configuration of a voice recognition device according to a second embodiment. A component that corresponds to an embodiment as already described will be provided with an identical sign and a redundant description will be provided only in a case of need.

The present embodiment further includes a weight processing unit 24 in the similar keyword identification unit 20. The weight processing unit 24 executes a process that is based on weighting information that is registered in a dictionary 30. For example, weighting information such as whether a first-win process is prioritized for a specific keyword or whether a process that is based on a storage time is prioritized is registered in the dictionary 30.

For example, weighting information to increase a degree of priority of a storage process for a keyword that includes a common word “GATSU” such as “ICHI GATSU” (a Japanese language that means January in English), “NI GATSU” (a Japanese language that means February in English), or “SAN GATSU” (a Japanese language that means March in English), as well as information of a corresponding identification code ID, is registered in the dictionary 30. For voice data that includes a common word, a similar keyword is likely to be detected. A degree of priority of a storage process is increased, so that recognition of a proper keyword and an identification code ID that corresponds thereto are output.

Furthermore, it is also possible to classify a keyword into a possibility of detecting a similar keyword being “present”/“absent” and register it in the dictionary 30. It is possible to register weighting information to increase a degree of priority of a first-win process for a keyword with no similar keyword, as well as information of an identification code ID thereof, in the dictionary 30.

Furthermore, in a case where an identification code ID that corresponds to a keyword with no similar keyword is output from the voice trigger detection unit 10, a configuration may be provided to output an identification code ID of a detected keyword without providing a mask period. Thereby, it is possible to avoid a delay of a process that is caused by providing a mask period.

Furthermore, in a case where multiple forward-matching keywords that include a common word in former parts of the keywords are present, weighting information of a keyword with a degree of priority of a storage process that is desired to be increased, as well as a corresponding identification code ID, is registered in the dictionary 30. For example, “MEILU WO OKURU” (a Japanese language that means “send a mail” in English) and “MEILU WO UKERU” (a Japanese language that means “receive a mail” in English) are forward-matching and there is a difference in “OKURU” and “UKERU” in latter parts thereof. For example, weighting information to prioritize a storage process is added to “MEILU WO OKURU” and registered in the dictionary 30. In a case where a forward-matching keyword is detected, it is not possible to execute proper recognition in a first-win process that is based on an order relation of a detected time. In a case where “MEILU WO OKURU” is detected as a keyword, the weight processing unit 24 executes a process based on weighting information that is registered in the dictionary 30 and executes output thereof to the degree-of-priority calculation unit 23. Therefore, weighting is executed for a keyword and a degree of priority of a storage process is increased, so that it is possible to execute proper recognition.

Furthermore, in a case where multiple backward-matching keywords that include a common word in latter parts of the keywords are present, weighting information to increase a degree of priority of a first-win treatment, as well as a corresponding identification code ID, is registered in the dictionary 30. For example, “JYUSHIN MEILU” (a Japanese language that means “an incoming mail” in English) and “SOUSHIN MEILU” (a Japanese language that means “an outgoing mail” in English) are backward-matching and there is a difference in “JYUSHIN” and “SOUSHIN” in a former part thereof. For example, weighting information to prioritize a first-win process is added to “JYUSHIN MEILU” and registered in the dictionary 30. In a case where multiple backward-matching keywords are detected, weighing to increase a degree of priority of a first-win treatment is executed, so that it is possible to execute proper recognition.

Furthermore, for example, an ease of detection of a keyword may be registered in the dictionary 30 for each keyword. A degree of priority of a storage process is decreased for a keyword that is difficult to be detected and a degree of priority of a storage process is increased for a keyword that is readily detected. In a case where information of an ease of detection that corresponds to a keyword that is output from the voice trigger detection unit 10 is present in the dictionary 30, the weight processing unit 24 supplies such information to the degree-of-priority calculation unit 23. It is possible for the degree-of-priority calculation unit 23 to execute calculation of a degree of priority by taking into consideration a length of a storage time, that is, an ease of detection of a similarity between a keyword and voice data.

Based on information from the first-win processing unit 21, the storage processing unit 22, and the weight processing unit 24, it is possible for the degree-of-priority calculation unit 23 to calculate a degree of priority based on a predetermined calculation formula. For example, the degree-of-priority calculation unit 23 calculates a degree of priority of each keyword based on information that indicates an order relation of a detected time of the first-win processing unit 21, storage time information of the storage processing unit 22, and weighting information of the weight processing unit 24, and outputs an identification code ID that corresponds to a keyword with a highest degree of priority.

For example, in a case where only one keyword is detected for voice data in a predetermined mask period, an identification code ID that corresponds to a detected keyword is output. In a case where multiple keywords are detected in a predetermined mask period, a degree of priority is calculated based on a time when a keyword is detected, a storage time of each keyword, and weighting information from the weight processing unit 24, an identification code ID that corresponds to a keyword with a highest degree of priority is output.

According to the present embodiment, a degree of priority is calculated by taking into consideration weighting information that is preliminarily set for each keyword and an identification code ID that corresponds to a keyword with a highest degree of priority is output. Therefore, a degree of priority of a keyword is calculated based on weighting information that is preliminarily registered by taking into consideration a characteristic of each keyword in addition to information of an order relation of a detected time of a keyword and information of a storage time that indicates a similarity between each keyword and voice date, so that it is possible to recognize a keyword with high reliability.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A voice recognition device, comprising:
a voice trigger detection unit that detects a keyword from a voice signal; and
a similar keyword identification unit that calculates a degree of priority of the keyword depending on a time when the keyword is detected and a similarity between the voice signal and the keyword and outputs an identification code that corresponds to the keyword based on the degree of priority.

2. The voice recognition device according to claim 1, wherein the similar keyword identification unit outputs, in a case where the voice trigger detection unit detects multiple keywords within a predetermined period of time, an identification code that corresponds to a keyword with a highest degree of priority within the predetermined period of time.

3. The voice recognition device according to claim 1, wherein the similar keyword identification unit includes:
a first-win processing unit that determines a degree of priority of the keyword based on a time when the keyword is detected;
a storage processing unit that determines a degree of priority of the keyword based on a length of time when a value that indicates the similarity satisfies a predetermined condition; and
a degree-of-priority calculation unit that calculates the degree of priority depending on an output signal of the first-win processing unit and an output signal of the storage processing unit.

4. The voice recognition device according to claim 3, wherein the voice trigger detection unit compares the voice signal and a preliminarily registered phonemic pattern to calculate a value that indicates the similarity.

5. The voice recognition device according to claim 2, wherein the predetermined period of time is set from a time when the voice trigger detection unit detects a first keyword among the multiple keywords.

6. The voice recognition device according to claim 4, comprising:
a dictionary that holds weighting information for a specific keyword; and
a weight processing unit that supplies, in a case where the voice trigger detection unit detects the specific keyword, the weighting information to the degree-of-priority calculation unit.

7. The voice recognition device according to claim 2, wherein the similar keyword identification unit stops output of the identification code within the predetermined period of time.

8. The voice recognition device according to claim 6, wherein the weighting information includes information on whether a degree of priority based on a time when the keyword is detected or a degree of priory based on a length of time when a value that indicates the similarity satisfies the predetermined condition is prioritized.

9. The voice recognition device according to claim 6, wherein the weighting information includes information to increase a degree of priority of a keyword with increasing a length of time that satisfies the predetermined condition, for a keyword that includes a word common to another keyword.

10. The voice recognition device according to claim 6, wherein the weighting information includes information to increase a degree of priority of a keyword with increasing a length of time that satisfies the predetermined condition, for a keyword that includes a word common to another keyword in a former part.

11. The voice recognition device according to claim 6, wherein the weighting information includes information to increase a degree of priority based on a time when the keyword is detected, for a keyword that includes a word common to another keyword in a latter part.

12. A voice recognition method, comprising:
a detection step of detecting a keyword from a voice signal;
a step of calculating, in a case where multiple keywords are detected within a predetermined period of time in the detection step, degrees of priority of the multiple keywords depending on each of times when the multiple keywords are detected and a similarity between the voice signal and a keyword; and
an output step of outputting an identification code that corresponds to a keyword with a highest degree of priority that is calculated in the calculation step.

13. The voice recognition method according to claim 12, wherein the predetermined period of time is set from a time when a first keyword among the multiple keywords is detected.

14. The voice recognition method according to claim 12, wherein the step of calculating a degree of priority includes a step of calculating the degree of priority based on a length of time when a value that indicates the similarity satisfies a predetermined condition.

15. The voice recognition method according to claim 12, wherein the step of calculating a degree of priority includes a step of calculating the degree of priority based on an order relation of a time when the keyword is detected.

16. The voice recognition method according to claim 15, wherein the step of calculating a degree of priority includes a step of increasing a degree of priority of a keyword with the detected time that is early.

17. The voice recognition method according to claim 12, wherein the step of calculating a degree of priority includes a step of calculating the degree of priority based on weighting information that is preliminarily provided to the keyword.

18. The voice recognition method according to claim 12, wherein the step of outputting an identification code includes a step of stopping output of the identification code within the predetermined period of time.

19. The voice recognition method according to claim 14, wherein the step of calculating a degree of priority includes a step of increasing a degree of priority of a keyword with increasing a length of time when the predetermined condition is satisfied, for a keyword that includes a word common to another keyword in a former part.

20. The voice recognition method according to claim 15, wherein the step of calculating a degree of priority includes a step of increasing a degree of priority of a keyword with a detected time that is early, for a keyword that includes a word common to another keyword in a latter part.
